(19) United States
(12) Patent Application Publication
(10) Pub. No.: US 2012/0216153 A1
(43) Pub. Date: Aug. 23, 2012

(54) HANDHELD DEVICES, ELECTRONIC DEVICES, AND DATA TRANSMISSION METHODS AND COMPUTER PROGRAM PRODUCTS THEREOF

(75) Inventor: Kim Yeung Sip, Taipei Hsien (TW)

(73) Assignee: ACER INCORPORATED, Taipei Hsien (TW)

(21) Appl. No.: 13/242,897

(22) Filed: Sep. 23, 2011

(30) Foreign Application Priority Data
Feb. 22, 2011 (TW) 100105738

(51) Int. Cl. G06F 3/033

(52) U.S. Cl. 715/863

(57) ABSTRACT

Data transmission methods for handheld devices are provided. The data transmission method includes the steps of: receiving a gesture input; determining whether the gesture input matches a predetermined gesture; and if so, obtaining directional information corresponding to the gesture input and transmitting a file and the directional information to at least one electronic device such that display of a user interface of the at least one electronic device generates a display effect corresponding to the gesture according to the directional information.

### CROSS REFERENCE TO RELATED APPLICATIONS

This Application claims priority of Taiwan Application No. 100105738, filed on Feb. 22, 2011, and the entirety of which is incorporated by reference herein.

### BACKGROUND OF THE INVENTION

1. Field of the Invention

The disclosure relates generally to handheld devices and related data transmission methods, and, more particularly to handheld devices and related data transmission methods capable of performing data sharing among devices which are located within a short range and are located in positions known to each other.

2. Description of the Related Art

Recently, handheld devices, such as mobile phones, smart phones or PDAs (Personal Digital Assistants), have become more and more technically advanced and multifunctional. Because of the conveniences of these devices, the devices have become necessities of life.

For some handheld devices, such as smart phones, PDAs, tablet PCs and so on, a touch screen which is directly touchable may be provided as a main input device for users to control functions thereof. Users of the handheld devices can slide their fingers to touch the items displayed by the touch screen to issue a command, and perform or control operations corresponding to the selected items. For example, users can click on a drawing button or icon displayed on the touch screen to activate a drawing function, or can click on a navigation button or icon displayed on the touch screen to activate a GPS navigation function.

As user requirements and behaviors change, data (e.g. multimedia files, messages or the like) sharing capability among different devices have become necessities of the handheld devices. Generally, when data is to be shared, users may perform a number of operations to start data transmission. For example, users may have to select data to be shared/transmitted first, select to transmit the data and then select to transmit the data to a user or device and that selects the data to be transmitted via a type of communication protocol, such as via the wireless network, via the Bluetooth or the infra-red communication protocol. After the communication protocol is determined, the determined communication protocol must be activated and the shared data can then be sent to the user to be shared via the activated communication protocol. Such a complex operation and data sharing method, however, may not meet user requirements any more. Therefore, it is desired to provide a more attractive data sharing and data transmission method for users.

### BRIEF SUMMARY OF THE INVENTION

Handheld devices and data transmission methods thereof are provided to provide data sharing among devices located in known positions within a short range.

In an embodiment of a data transmission method, applied to a handheld device at least comprising a touch-sensitive display unit, a gesture input is first received from the touch-sensitive display unit. It is then determined whether the gesture input matches a predetermined gesture. When the gesture input matches the predetermined gesture, directional information corresponding to the gesture is obtained and a file and the directional information are transmitted to at least one electronic device, for directing a display of a user interface of the electronic device to generate a display effect corresponding to the gesture input according to the directional information.

An embodiment of a handheld device comprises a storage unit, a touch-sensitive display unit and a processing unit. The storage unit comprises at least one file. The processing unit is arranged for receiving a gesture input from the touch-sensitive display unit to determine whether the gesture input matches a predetermined gesture, and when the gesture input matches the predetermined gesture, obtaining directional information corresponding to the gesture input and transmitting the at least one file and the directional information to at least one electronic device, thereby directing a display of a user interface of the electronic device to generate a display effect corresponding to the gesture input according to the directional information.

In another embodiment of a data transmission method, applied to an electronic device at least comprising a display unit, a file transmission request is first received, wherein the file transmission request comprises directional information and a file. Then, the file is received and a display effect corresponding to the directional information is generated on the display of a user interface of the display unit in response to the file transmission request.

Another embodiment of an electronic device comprises a display unit and a processing unit. The display unit is arranged for displaying a user interface. The processing unit is arranged for receiving a file transmission request comprising directional information and a file, and receiving the file and generating a display effect corresponding to the directional information on the display of the user interface of the display unit in response to the file transmission request.

Data transmission methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a data transmission system of the invention;

FIG. 2 is a flowchart of an embodiment of a data transmission method of the invention;

FIGS. 3A to 3H are schematic diagrams illustrating an embodiment of operations of the data transmission method of the invention;

FIG. 3I is a schematic diagram illustrating an embodiment of an operation result of the data transmission method of the invention;

FIG. 4 is a schematic diagram illustrating an embodiment of an operation of the data transmission method of the invention;

FIG. 5 is a flowchart of another embodiment of a data transmission method of the invention;

FIGS. 6A to 6D are schematic diagrams illustrating an embodiment of operation result of the data transmission method of the invention;

FIGS. 7A to 7B are schematic diagrams illustrating an embodiment of operation result of the data transmission method of the invention;

FIGS. 8A to 8B are schematic diagrams illustrating an embodiment of operation result of the data transmission method of the invention;

FIG. 9A is a schematic diagram illustrating an embodiment of an operation result of the data transmission method of the invention;

FIG. 9B is a schematic diagram illustrating an embodiment of a gesture of the data transmission method of the invention; and

FIG. 10 is a schematic diagram illustrating an embodiment of a data transmission method and responsive operation result of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

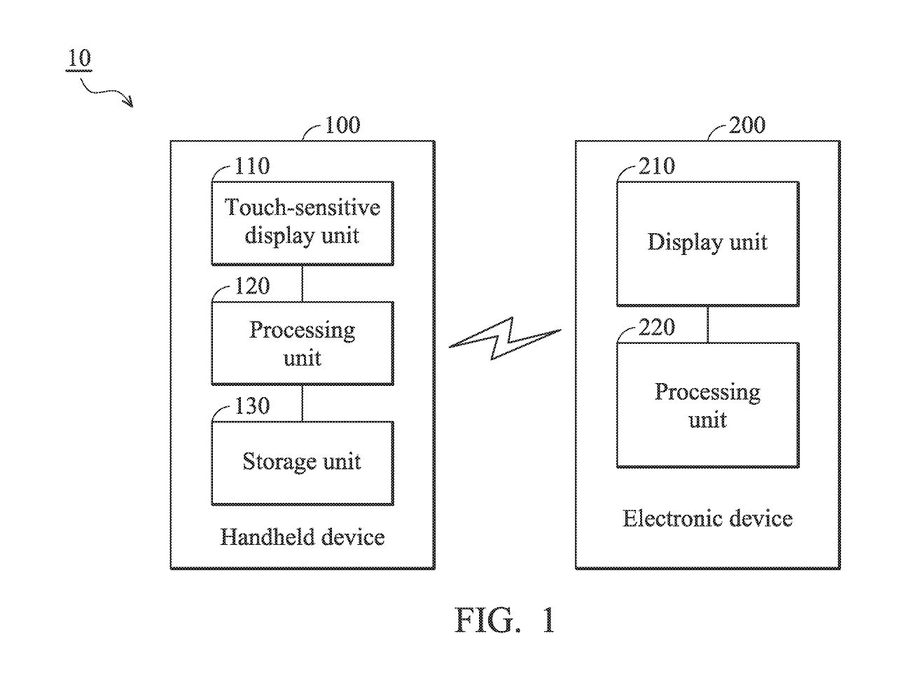

FIG. 1 is a schematic diagram illustrating an embodiment of a data transmission system of the invention. The data transmission system 10 of the invention at least comprises a handheld device 100 and an electronic device 200, wherein the handheld device 100 and the electronic device 200 are within a limited distance, and are communicated with each other through a wireless communication protocol, such as an infra-red (IR), or Bluetooth protocol and so on. The electronic device 200 may be an electronic device which is the same as the handheld device 100 or other type of electronic device, such as a smart phone, a PDA (Personal Digital Assistant), a laptop computer or a tablet computer.

The handheld device 100 may at least comprise a touch-sensitive display unit 110, a processing unit 120 and a storage unit 130. It is understood that, in some embodiments, the touch-sensitive display unit 110 may be integrated with a touch-sensitive device (not shown). The touch-sensitive device has a touch-sensitive surface comprising sensors in at least one dimension to detect contact and movement of at least one object (input tool), such as a pen/stylus or finger near or on the touch-sensitive surface. The touch-sensitive display unit 110 can display related data, such as texts, figures, interfaces, and/or information.

The storage unit 130 stores at least one file and a number of gesture recognition data. The gesture recognition data within the storage unit 130 may further be provided to the processing unit 120 for subsequent determination of the type of gesture input. The processing unit 120 which is coupled to the touch-sensitive display unit 110 can perform the data transmission method of the present invention, which will be discussed further in the following paragraphs.

The electronic device 200 at least comprises a display unit 210 and a processing unit 220, wherein the display unit 210 at least displays a user interface and related data and icons. Similarly, in one embodiment, the display unit 210 is the same as the touch-sensitive display unit 110.

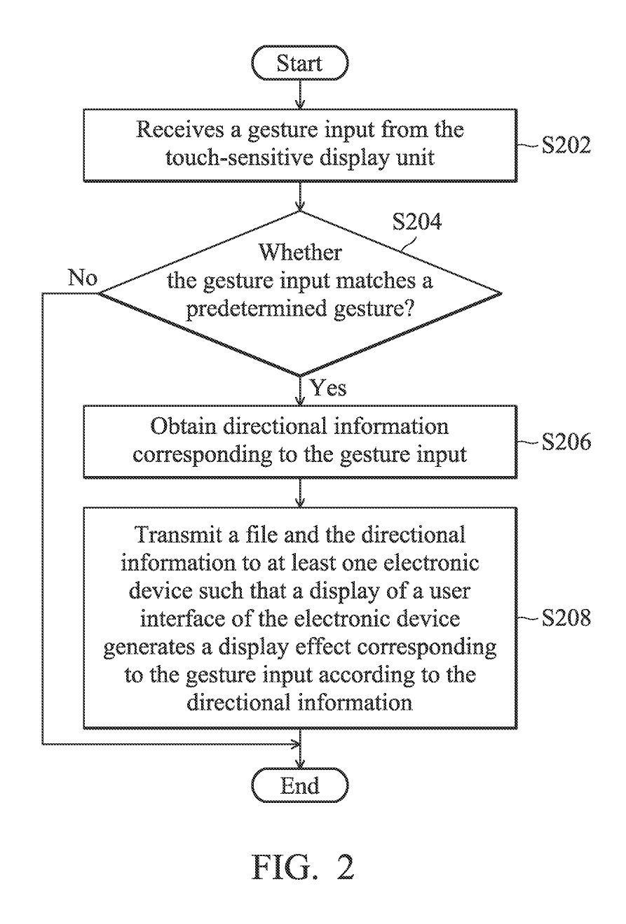

FIG. 2 is a flowchart of an embodiment of a data transmission method of the invention. Please refer to FIGS. 1 and 2. The data transmission method can be applied to an electronic device, such as a portable device, e.g. a PDA, a PDA phone, a smart phone, a mobile phone, an MID, a laptop computer, a tablet computer, a car computer, a digital camera, a multi-media player, a game device, or any other type of handheld device. However, it is to be understood that the invention is not limited thereto. It is to be noted that, in this embodiment, the handheld device comprises a touch-sensitive display unit.

First, in step S202, the processing unit 120 receives a gesture input from the touch-sensitive display unit 110. In this step, the processing unit 120 may detect a touch on the touch-sensitive display unit 110 and determine whether the touch is a gesture input. When the touch is determined as the gesture input, the processing unit 120 receives the gesture inputted on the touch-sensitive display unit 110. Note that users are able to input a gesture via a movement of at least one object (input tool), such as a pen/stylus or finger near or on the touch-sensitive surface. Thereafter, in step S204, the processing unit 120 determines whether the gesture input matches a predetermined gesture. To be more specific, determination of whether the gesture input matches a predetermined gesture is performed by determining whether the gesture input matches a gesture for transmission request. That is, the predetermined gesture is a gesture which represents a transmission request. For example, when a flicking gesture for transmission request is defined as an action that presses an icon of a file to be transmitted and flicks the icon out by their finger, the determination of whether the gesture input matches a predetermined gesture can be performed by determining whether the gesture input matches the flicking gesture. When the gesture input is determined as not matching with the predetermined gesture, the processing unit 120 may perform other processes that corresponds to the gesture input, such as to activate a selection item or perform an operation on the selected item, to end the operation.

When the gesture input is determined as matching with the predetermined gesture, in step S206, the processing unit 120 obtains directional information corresponding to the gesture input.

It is to be understood that, the directional information may be determined based on a reference vector and a set of gesture information relative to the gesture, wherein the reference vector is a vector which is perpendicular to the display plane of the handheld device, i.e. a normal vector for the display plane of the handheld device. The set of gesture information is information regarding the movement detected on the touch-sensitive display unit 110, such as the starting point, the ending point and the velocity for the gesture. In some embodiments, the reference vector may be obtained by using a set of sensors. The set of sensors may at least comprise at least one of a G-sensor, a Gyroscope and an e-compass or other direction sensors. By the sensed data provided by the sensors, a vector perpendicular to any vector on the display plane of the handheld device (i.e. the reference vector) as well as the velocity, acceleration and other information related to the handheld device can be obtained. Because the gesture information corresponds to the touch-sensitive display unit, if the absolute position of the touch-sensitive display unit is changed due to operation or some reasons, other electronic devices will not recognize the actual direction that the gesture information generated on the transmitting device at the transmitting end represents based on the gesture information received from the transmitting device at the transmitting end. Thus, it may erroneously determine a wrong direction or result in an incorrect result when a determination of the transmission direction that is the direction the file being sent out is to be made based on the directional information.

Since the reference vector is an absolute vector in the three dimensional space and it consists in all other devices and is known by these devices, thus, in this embodiment, the reference vector can be further applied to determine correct directional information. In this embodiment, a reference vector, which is perpendicular to the display plane of the handheld device and determined by using the sensed data provided by the sensors, can serve as a reference to map the aforementioned gesture information (e.g. information regarding the starting point and the ending point for the gesture and the velocity of device) into the three dimensional space to generate an absolute directional information corresponding to the reference vector on the three dimensional space. The absolute directional information corresponding to the reference vector on the three dimensional space can then be set as the directional information corresponding to the gesture input. The directional information represents information regarding the direction that the gesture is sent, so other electronic devices may correctly decode/copy the gesture direction represented by the directional information.

For example, the aforementioned sensors may be first utilized to obtain information regarding the reference vector, the velocity information and the acceleration information for the handheld device 100 and so on, and a three-dimensional (3-D) mapping operation is then performed with the positions of the starting point P of the gesture and the ending point Q of the gesture by projecting the positions to obtain the absolute 3-D space position P′ and 3-D space position Q′ corresponding to the reference vector respectively. Thereafter, the electronic device may know the actual direction of the vector that corresponds to the gesture (e.g. the flicking direction) based on the reference vector and the calculated points P′ and Q′.

After the directional information has been obtained, in step S208, the processing unit 120 transmits a file and the directional information to at least one electronic device 200. The transmitted directional information will direct the display of a user interface of the electronic device 200 to generate a display effect corresponding to the gesture according to the directional information. The file may comprise multimedia files, such as audio, video, picture files and other type of files which can be transmitted and shared to each other. For example, a header data containing the file data and the directional information can be transmitted to the electronic device 200. As aforementioned, the handheld device 100 may utilize a vector P′ (a vector from the point P′->Q′) as well as information regarding detected velocity, acceleration and/or the timestamp as the content of the header data that is to be transmitted to the electronic device 200 and transmit a file transmission request containing the header data and the file to be shared to the electronic device 200. Note that the timestamp is used for compensating for the transmission delay and thus the electronic device 200 can simulate the correct transmitted direction by using the timestamp.

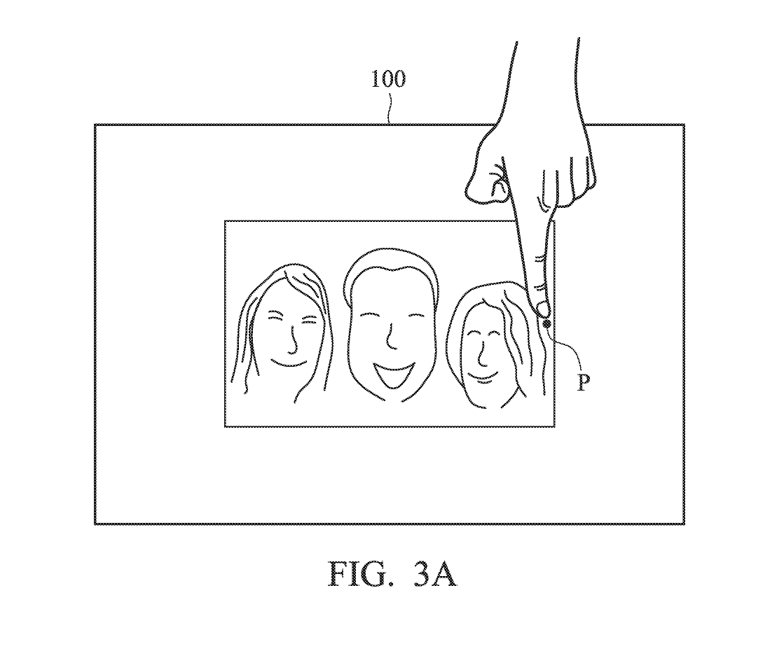

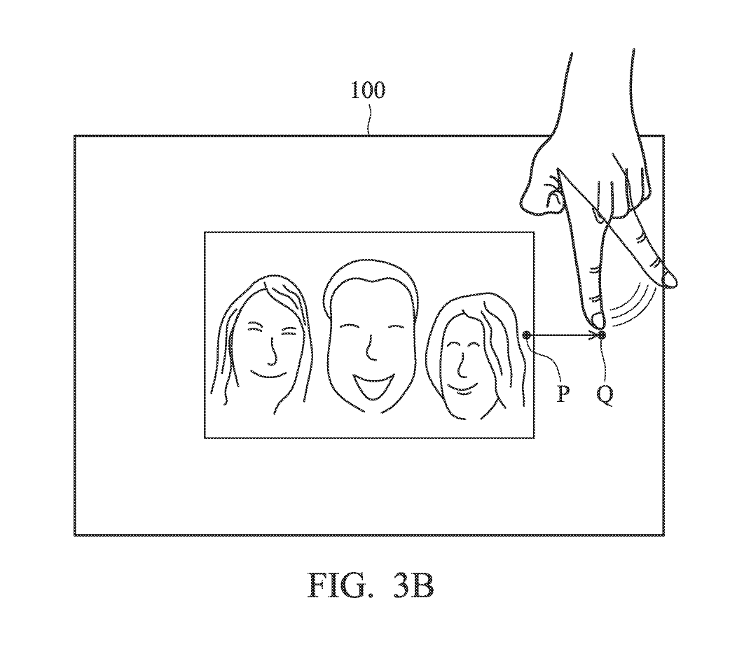

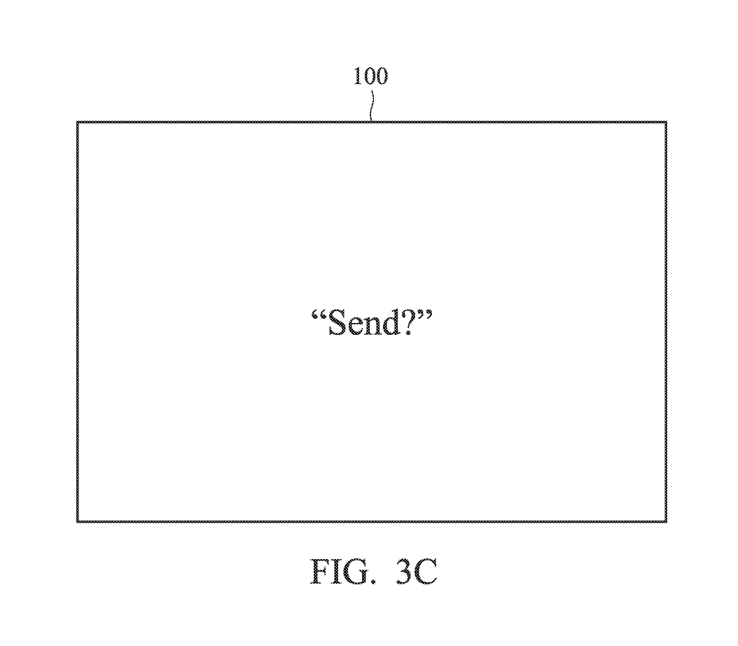

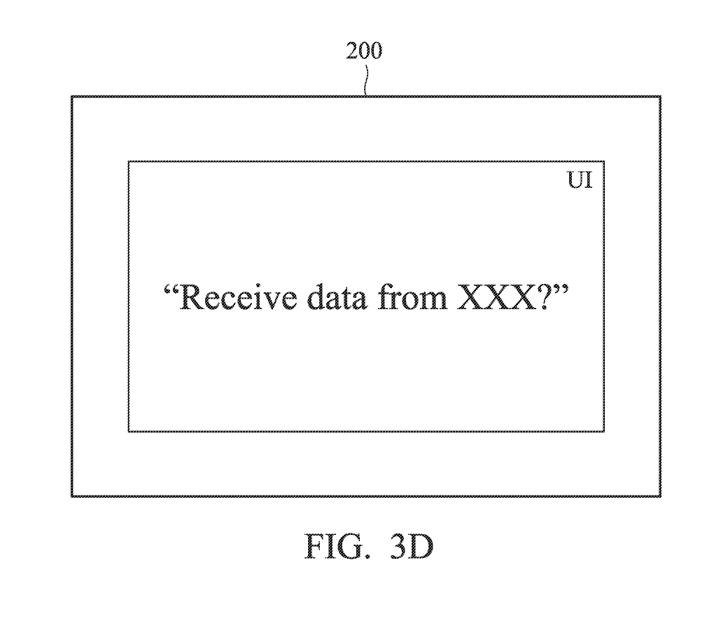

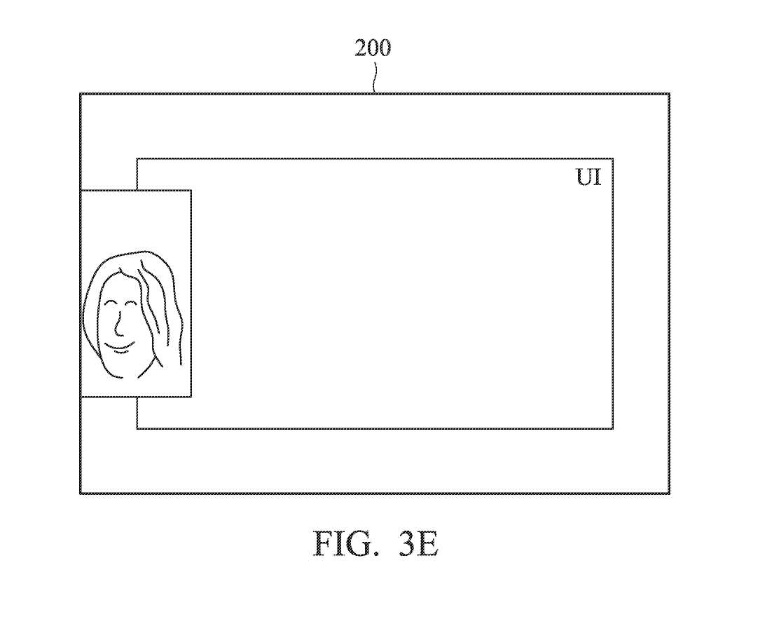

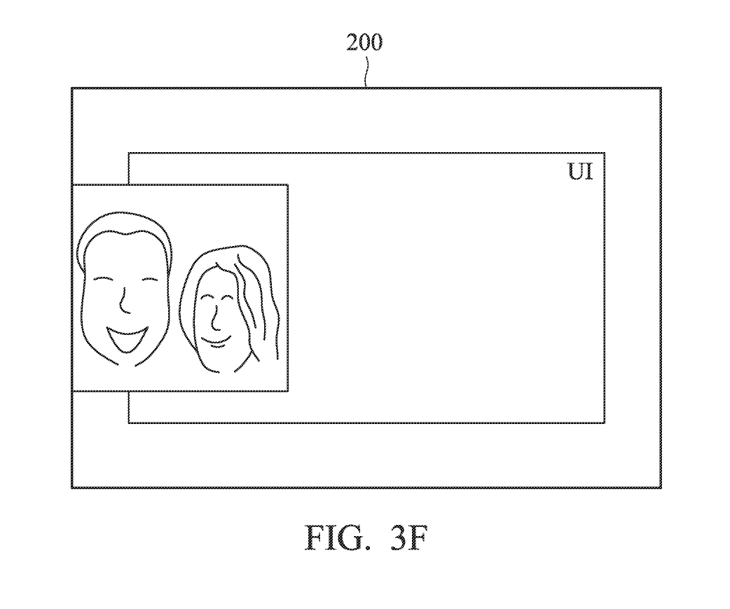

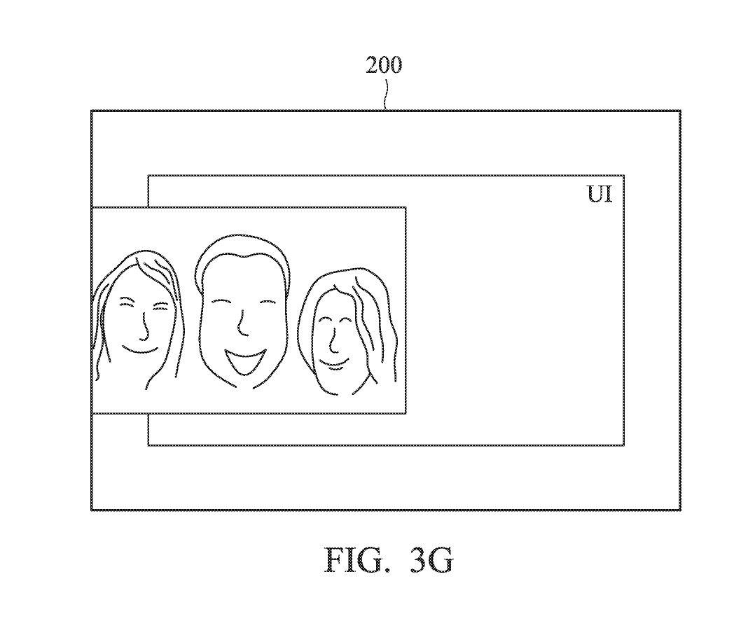

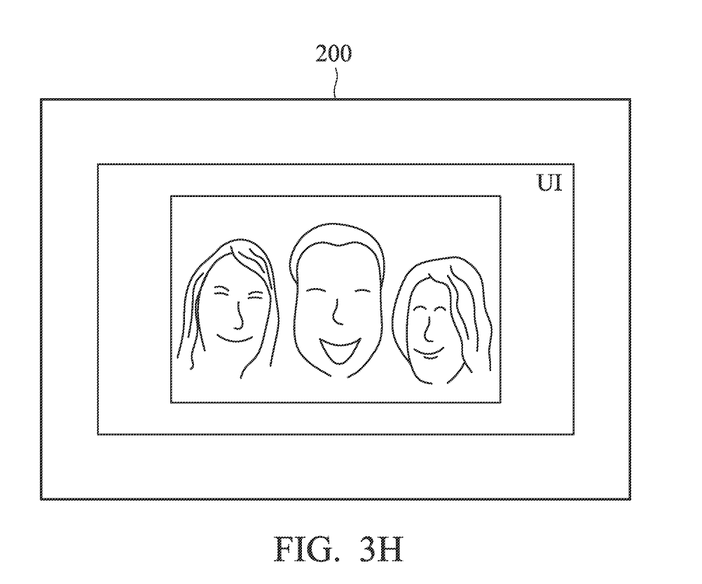

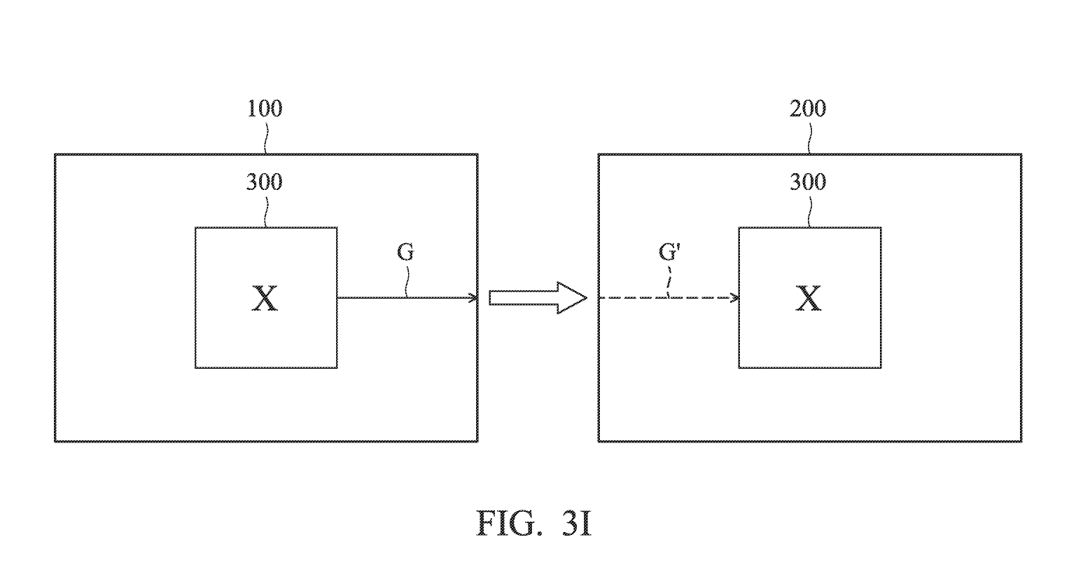

FIGS. 3A to 3H are schematic diagrams illustrating an embodiment of an example of a user interface variation and responsive operation result of the data transmission method of the invention, wherein FIGS. 3A-3C correspond to the handheld device 100 and FIGS. 3D-3H correspond to the electronic device 200.

For explanation, data sharing for picture files and peer-to-peer (P2P) sharing are illustrated as examples in this embodiment, and those skilled in the art will understand that the display effect of the present invention is not limited thereto. When the file to be shared is a picture file, the content of the picture file can be directly displayed when receiving it. As shown in FIG. 3A, when a user attempts to perform a data transmission/data sharing operation, the user presses a file to be shared at point P by their finger to select the file to be shared. Then, the user drags and drops the file from point P to point Q by their finger and then stops pressing the file at point Q to represent that a file transmission operation is to be performed (FIG. 3B). Thus, the processing unit 120 detects this gesture and determines that it is a predetermined gesture, and then prompts the user to confirm whether a transmission operation is to be performed (FIG. 3C) so as to confirm the operation. When it is conformed by the user, the processing unit 120 performs step S206 to obtain directional information corresponding to the gesture input and then performs step S208 to transmit the file and the directional information to the electronic device 200 after the directional information has been obtained. In one embodiment, the processing unit 120 may simultaneously display a motion picture effect regarding a file being sent on the touch-sensitive display unit 110 when the file transmission starts.

In some embodiments, the handheld device 100 may configure a known sharing group in advance, and then selectively share the data to a portion of or all of members within the sharing group. In a specific embodiment, the electronic device 200 and the handheld device 100 are face to face, so the handheld device 100 may directly perform a P2P transmission with the electronic device 200 and the display of the user interface of the electronic device 200 will represent a responsive display effect.

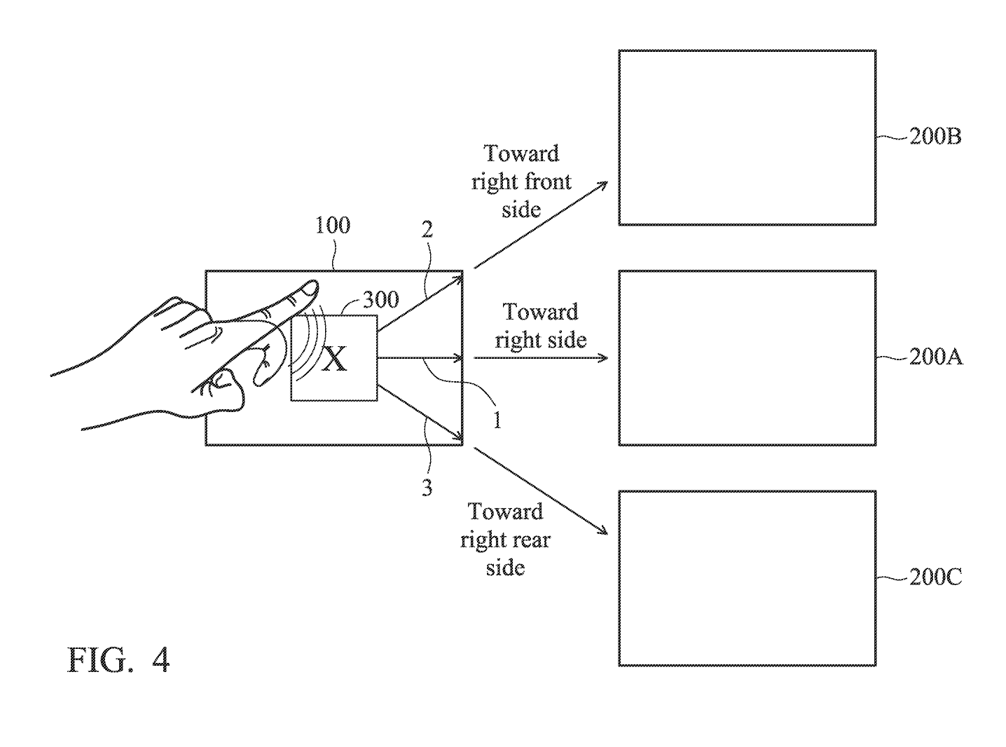

In one embodiment, the handheld device 100 (i.e. the transmitting device) may transmit the shared file to one electronic device 200 per one time, wherein the electronic device which the shared file is to be transmitted to can be determined according to the directional information of the gesture. It is to be note that, the handheld device 100 and the electronic device 200 are located within a limited distance and relative positions are known to each other in advance. In one embodiment, it is assumed that there may be a central device (not shown) that records the position information of the handheld device 100 and all of the electronic devices 200. Therefore, the relative positions of the handheld device 100 and each electronic device 200 can be known and are within a limited distance, so that the central device can recognize which electronic device 200 that the shared data should be transmitted to, based on the directional information of the gesture upon reception of the transmission request. For example, as shown in FIG. 4, assume that three electronic devices 200A, 200B and 200C are located at the right hand side of the handheld device 100, in front of the handheld device 100 at the right hand side, and behind the handheld device 100 at the right hand side, respectively. When detecting a flicking gesture that flicks the file toward the right side of the handheld device (in view of the handheld device user) (gesture 1), a flicking gesture that flicks the file toward the right front side of the handheld device (gesture 2) and a flicking gesture that flicks the file toward the right rear side of the handheld device (gesture 3), the processing unit 120 can transmit the selected data to the electronic devices 200A, 200B and 200C, respectively.

When the electronic device 200 receives the transmission request and prepares to receive the file, the display of its user interface will generate a display effect corresponding to the gesture, as shown in FIGS. 3D-3H.

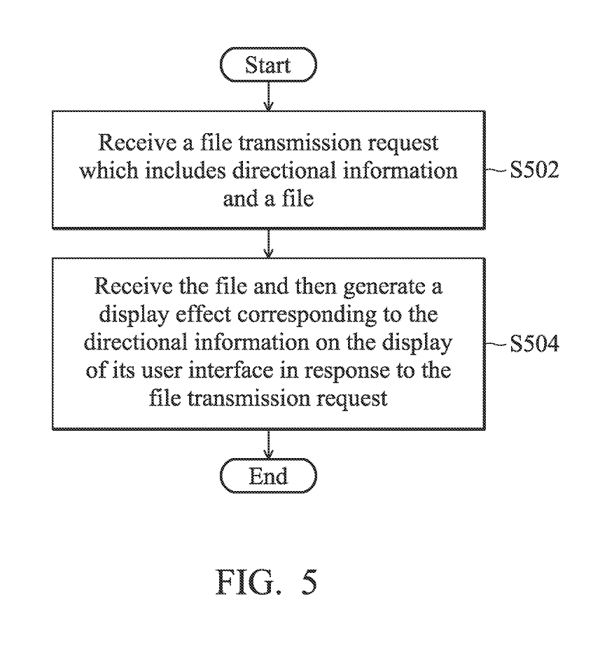

FIG. 5 is a flowchart of an embodiment of a data transmission method of the invention. The data transmission method can be applied to an electronic device, such as a TV, a desktop computer or the like, or a portable device, e.g. a PDA, a smart phone, a mobile phone, an MID, a laptop computer, a tablet computer, a car computer, a digital camera, a multi-media player, a game device, or any other type of handheld device; however, it is to be understood that the invention is not limited thereto. It is to be noted that, in this embodiment, the electronic device is the electronic device 200 shown in FIG. 1 and comprises a display unit 210, wherein the display unit 210 displays a user interface UI.

In step S502, the electronic device 200 receives a file transmission request, wherein the file transmission request includes directional information and a file.

When receiving the file transmission request, the electronic device 200 may further prompt the user to confirm whether to receive the file (FIG. 3D) so as to confirm the file transmission operation. When it is conformed by the user, in step S504, the electronic device 200 receives the file and then generates a display effect corresponding to the directional information on the display of its user interface UI in response to the file transmission request. The electronic device 200 may display a responsive motion picture effect based on the directional information within the file transmission request when receiving the file or after the file has been successfully received. As the handheld device 100 transmits the directional information to the electronic device 200, the electronic device 200 can determine the direction that the gesture of the handheld device 100 is directed to based on the directional information. For example, please refer to FIGS. 3A-3H. As shown in FIGS. 3A-3B, the direction that the gesture is directed to, is from left to right, and thus the electronic device 200 may obtain a vector which direction is from left to right according to the received directional information. Accordingly, the electronic device 200 generates a motion picture effect that step-by-step pushes the picture from left to right on the user interface UI of the display unit 210, as shown in FIGS. 3E-3H. Therefore, the user of the electronic device 200 can determine where the file is sent from and how the file is sent out accordingly. It is to be noted that, in the following embodiments, for illustration, the action represented by FIGS. 3A to 3H is illustrated using a simple operation schematic, as shown in FIG. 3I. FIG. 3I is a schematic diagram illustrating an embodiment of a data transmission method and responsive operation result of the data transmission method of the invention, which represents that the handheld device 100 shares the file 300 by using the predetermined gesture G, and the electronic device 200 generates a moving effect with the moving track G′ (as shown in FIGS. 3E-3H) on the user interface of the display unit 210 after the file has been received.

For explanation, some specific embodiments are illustrated as examples to explain the data transmission method and details for effect generation, and those skilled in the art will understand that the present invention is not limited thereto.

In some embodiments, the display of the user interface UI of the electronic device 200 generates the display effect corresponding to the directional information according to the directional information. The display of the user interface UI of the electronic device 200 generates the display effect that is changed in a direction which is the same as the directional information of the gesture.

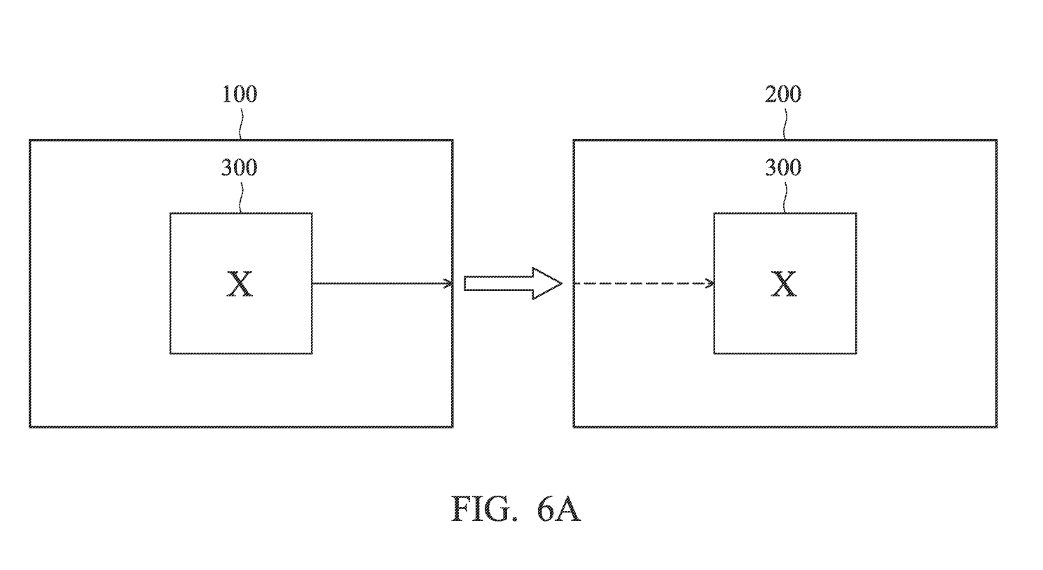

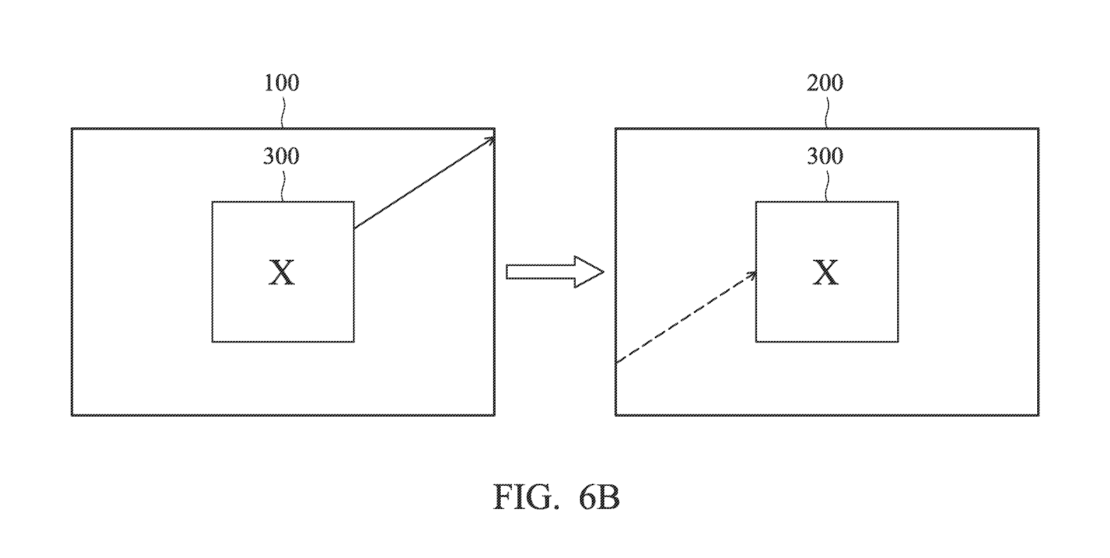

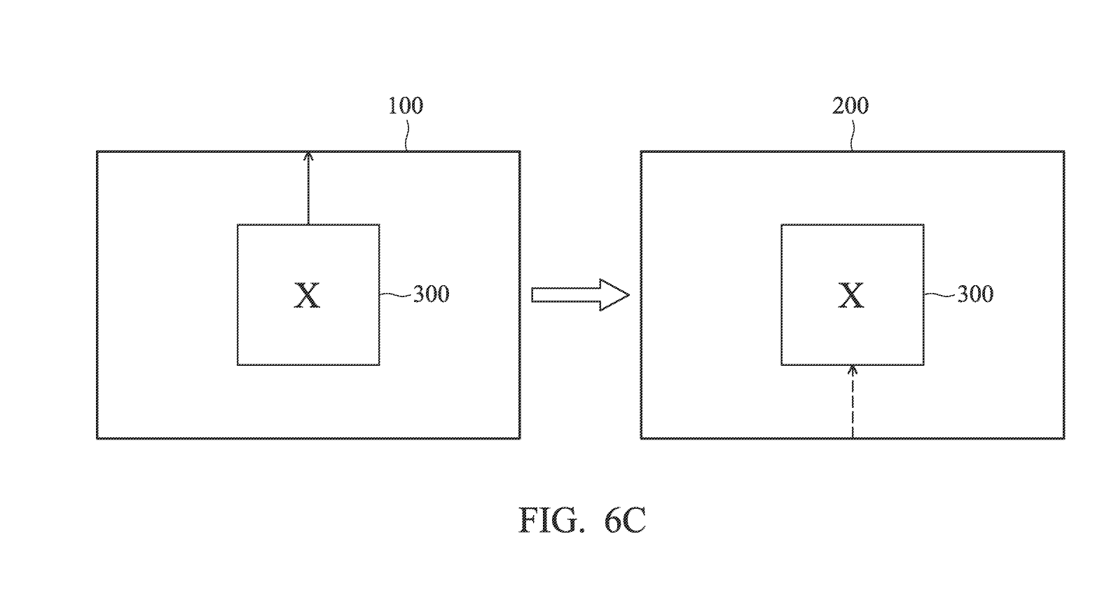

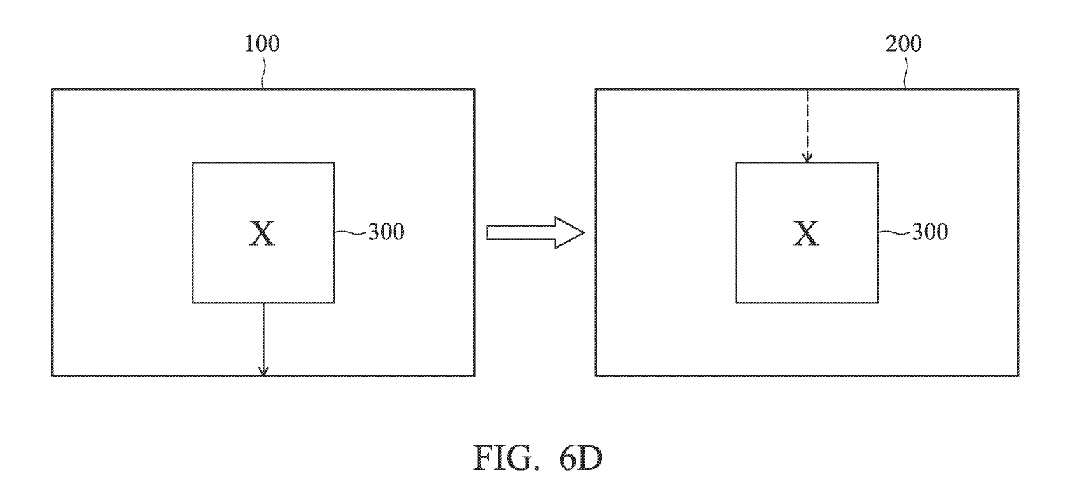

FIGS. 6A to 6D are schematic diagrams illustrating an embodiment of a data transmission method and operation result thereof of the invention. As shown in FIG. 6A, if the transmitting device 100 transmits the file 300 by a gesture with a direction from left to right, the user interface UI of the electronic device 200 may display a motion picture effect that is changed from left to right according to the received directional information to indicate that the transmitting device has sent out the file by a gesture that flicks from left to right. Similarly, if the transmitting device 100 transmits the file 300 by a gesture with a direction from a lower left to upper right area, a gesture with a direction from bottom to top and a gesture with a direction from top to bottom respectively, the user interface UI of the responsive receiving device 200 may respectively display a motion picture effect that is changed from a lower left to upper right area, from a bottom to a top and from a top to bottom area (as shown in FIGS. 6A-6D) according to the received directional information.

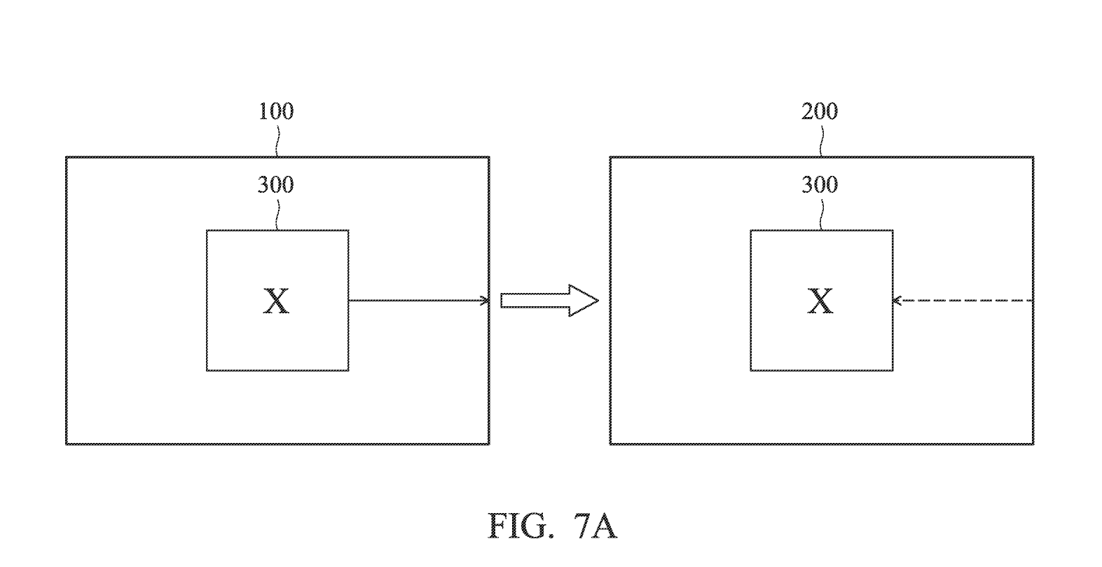

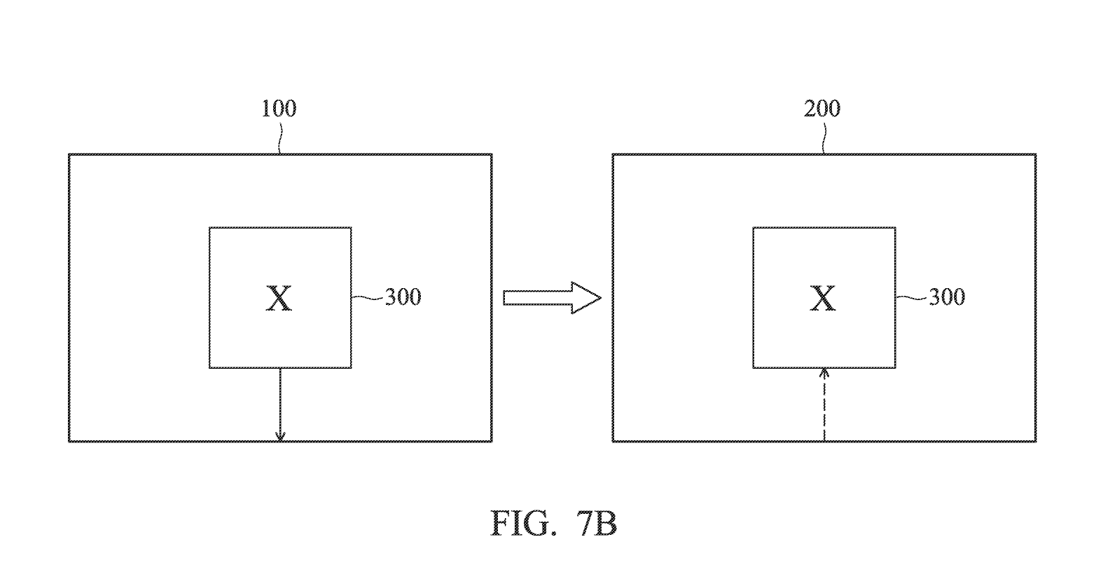

In some embodiments, the display of the user interface UI of the electronic device 200 generates the display effect corresponding to the directional information according to the directional information. The display of the user interface UI of the electronic device 200 generates the display effect that is changed in a direction opposite to the directional information of the gesture. Please refer to FIGS. 7A-7B, which are schematic diagrams illustrating another embodiment of a data transmission method and operation result thereof of the invention. As shown in FIGS. 7A and 7B, if the transmitting device 100 transmits the file 300 by a gesture with a direction from left to right or a gesture with a direction from up to bottom, the user interface UI of the electronic device 200 may respectively display a motion picture effect that is changed from right to left (FIG. 7A) or from bottom to up (FIG. 7B), which is changed in the opposite direction of the directional information according to the received directional information.

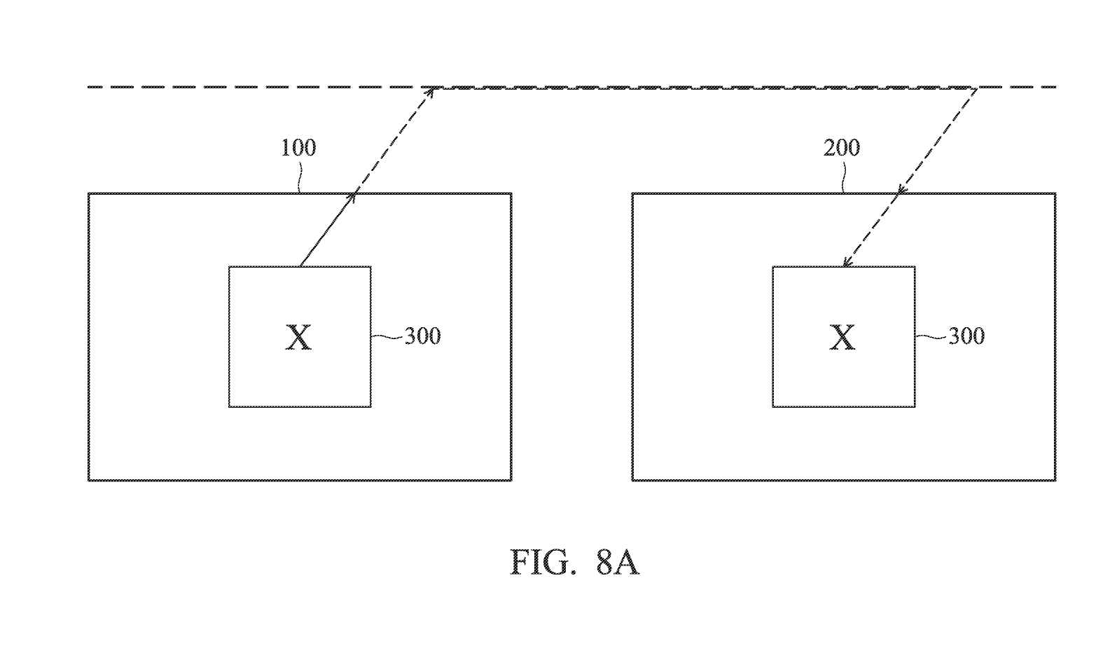

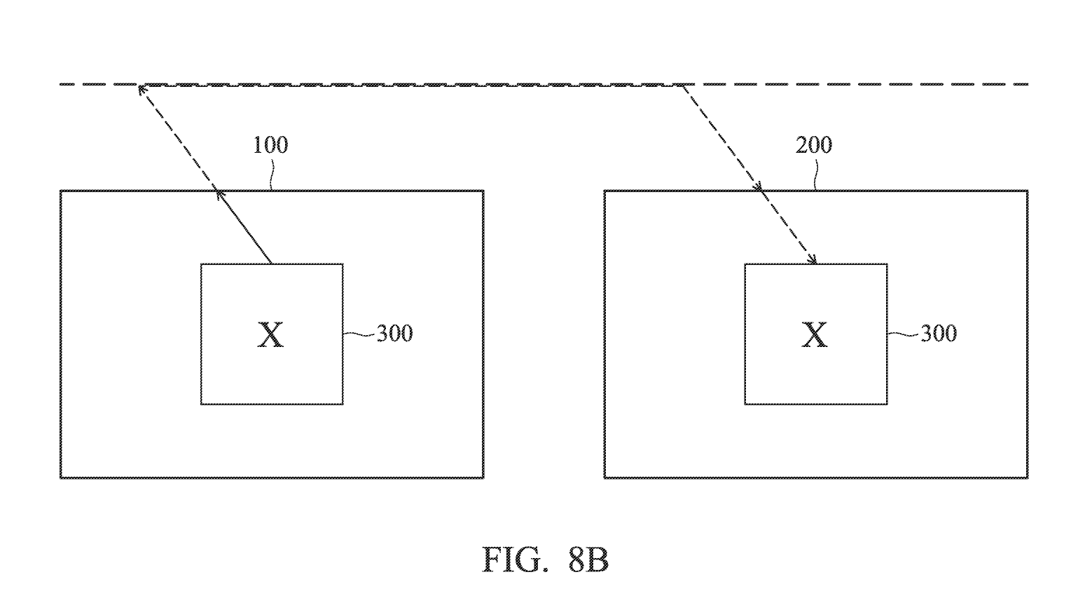

In some embodiments, the display of the user interface UI of the electronic device 200 generates the display effect corresponding to the directional information according to the directional information. The display of the user interface UI of the electronic device 200 generates the display effect that is changed in a reflection direction of the directional information of the gesture. Please refer to FIGS. 8A-8B, which are schematic diagrams illustrating another embodiment of a data transmission method and operation result thereof of the invention. As shown in FIG. 8A, if the transmitting device 100 transmits the file 300 by a gesture with a lower left to upper right direction, the user interface UI of the electronic device 200 may display a motion picture effect that is changed from an upper right to lower left direction, which generates an effect as same as that the file is sent from the reflection of a wall or a mirror. Similarly, as shown in FIG. 8B, if the transmitting device 100 transmits the file 300 by a gesture with a direction from a lower right to upper left direction, the user interface UI of the electronic device 200 may display a motion picture effect that is changed from an upper left to lower right direction, which is similar to the reflection direction of the directional information.

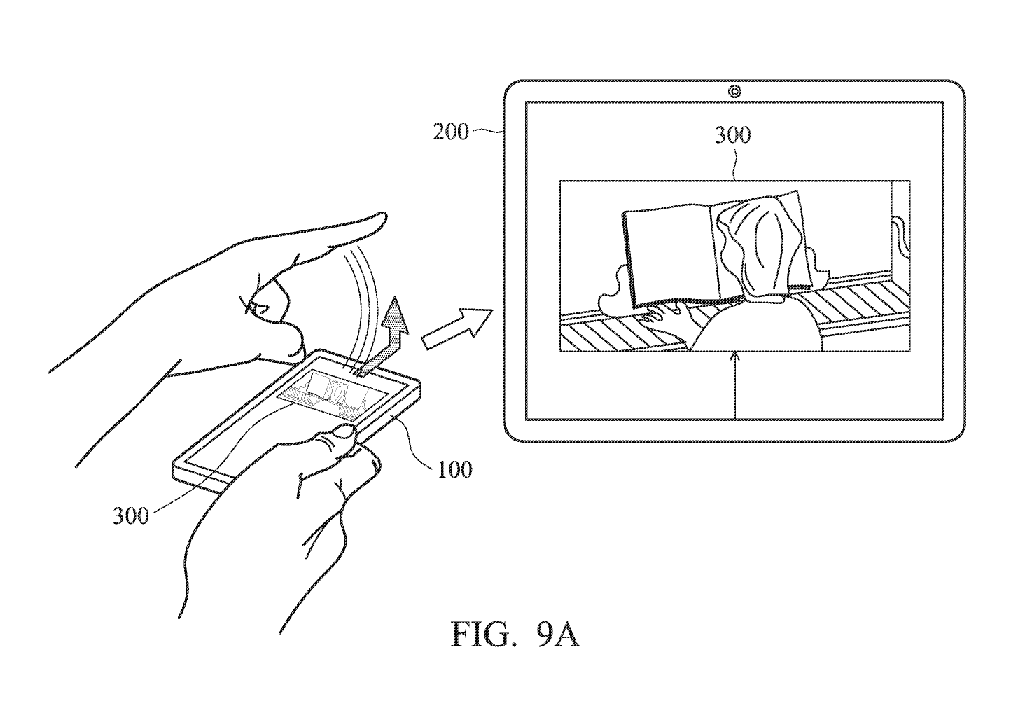

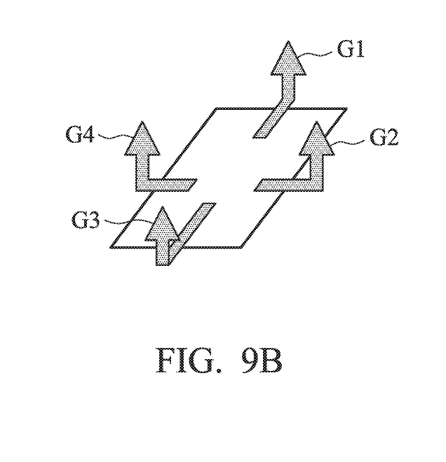

In some embodiments, the display plane of the display unit 210 of the electronic device 200 is perpendicular to the touch-sensitive display unit 110. That is, the electronic device 200 is located in a direction perpendicular to the handheld device 100 at the transmitting end. For example, the electronic device 200 may be a TV or a desktop computer, and the display plane of the display unit 210 is perpendicular to the touch-sensitive display unit 110 of the handheld device 100. Thus, as shown in FIG. 9A, a user may utilize a predetermined gesture, such as a gesture that flicks upward (the gesture G1 as shown in FIG. 9B) to issue a file transmission request and apply the data transmission method of the invention to perform data transmission and generate responsive display effect at the receiving device. Similarly, if there are a number of vertical electronic device 200, the user may separately utilize a gesture that flicks upward in a responsive direction (the gestures G2-G4 as shown in FIG. 9B) corresponding to the position of each device to transmit the file to one of or all of the electronic device 200 in response to the position or the direction of each electronic device, and generate a responsive display effect based on the directional information on the user interface UI of the selected electronic device 200.

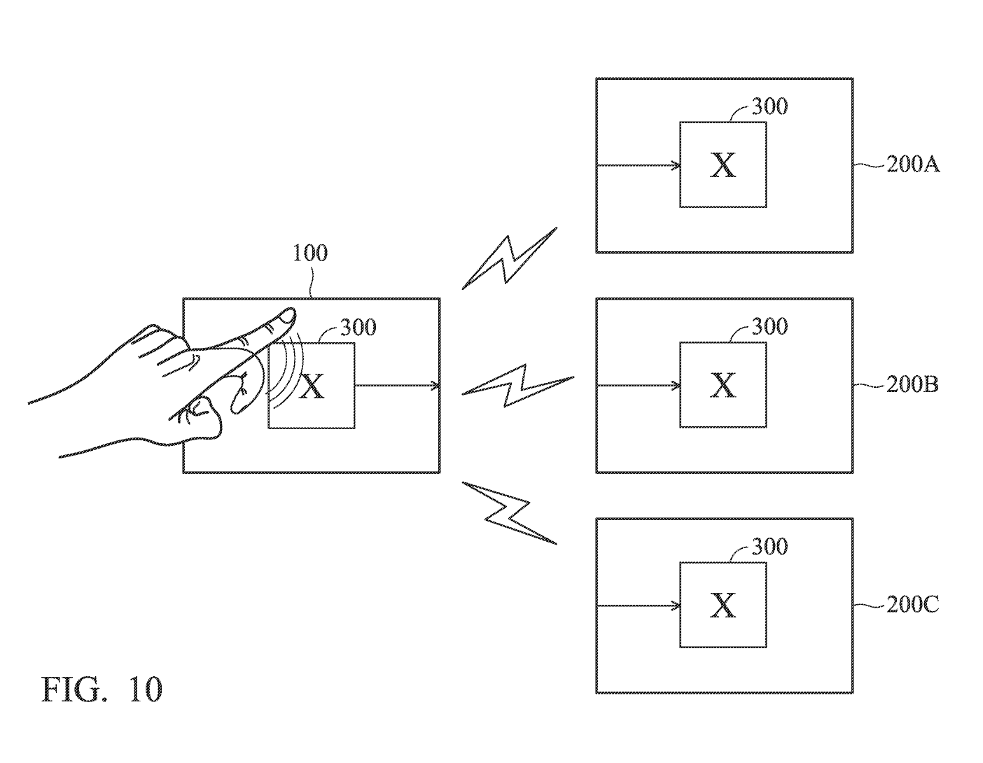

In some embodiments, the handheld device 100 may transmit the file to multiple electronic devices 200 at one time. It is to be noted that the handheld device 100 may have been configured for a known acceptable group including a plurality of electronic devices 200 in advance, and is so, all of the electronic devices 200 and the handheld device 100 would be located within a limited distance and their relative positions would be known to each other. Please refer to FIG. 10, which is a schematic diagram illustrating another embodiment of a data transmission method and operation result thereof of the invention. As shown in FIG. 10, if the transmitting device 100 transmits the file 300 by a gesture with a direction from left to right, the responsive user interfaces UI of the electronic devices 200A-200C may respectively display a motion picture effect that is changed from left to right according to the received directional information to indicate that the transmitting device has sent out the file by a gesture that flicks from left to right. Similarly, in another embodiment, different display effects can be generated on electronic devices located at different positions. For example, in the configuration shown in FIG. 10, if the transmitting device 100 transmits the file 300 by a gesture with a direction from left to right, the user interfaces UI of the responsive electronic devices 200A-200C may respectively display a motion picture effect that is changed in a direction which is the as same as the received directional information, a motion picture effect that is changed in a direction which is opposite to the received directional information, and a motion picture effect that is changed in a reflection direction of the received directional information.

Therefore, the data transmission methods and related data transmission systems of the invention can provide entertaining data sharing methods for users, and a file transmission command to transmit the file to be shared (e.g. pictures, audio files and so on) can be issued by intuitively using directional gestures, such that the display on the user interface of the electronic device located in a responsive direction can display a display effect corresponding to the gesture. By doing so, the electronic device at the receiving end may recognize the position of the transmitting device and the way that the transmitting device sends the file, thus, increasing fun of the data sharing operation. In addition, the data transmission methods and related handheld devices of the invention can perform a P2P sharing to share data to another peer or simultaneously share the data to multiple devices within a predetermined group user. Moreover, the data transmission methods and related handheld devices of the invention can directly display the shared data on the display unit of other electronic device, such as on the TV screen, making data sharing quicker and easier.

Data transmission methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A data transmission method, applied to a handheld device at least comprising a touch-sensitive display unit, the method comprising:
receiving a gesture input from the touch-sensitive display unit;
determining whether the gesture input matches a predetermined gesture; and
when the gesture input matches the predetermined gesture, obtaining directional information corresponding to the gesture input and transmitting a file and the directional information to at least one electronic device, thereby directing a display of a user interface of the electronic device to generate a display effect corresponding to the gesture input according to the directional information.

2. The data transmission method of claim 1, wherein the predetermined gesture is a gesture representing a transmission request.

3. The data transmission method of claim 1, wherein the at least one electronic device comprises a plurality of electronic devices and the step of transmitting the file and the directional information to the at least one electronic device further comprises:
transmitting the file to one of the electronic devices according to the directional information.

4. The data transmission method of claim 1, wherein the step of directing the display of the user interface of the electronic device to generate the display effect corresponding to the gesture according to the directional information further comprises:
directing the display of the user interface of the electronic device to represent the display effect that is changed in a direction which is the same as the directional information of the gesture.

5. The data transmission method of claim 1, wherein the step of directing the display of the user interface of the electronic device to generate the display effect corresponding to the gesture according to the directional information further comprises:
directing the display of the user interface of the electronic device to represent the display effect that is changed in a direction opposite to the directional information of the gesture.

6. The data transmission method of claim 1, wherein the step of directing the display of the user interface of the electronic device to generate the display effect corresponding to the gesture according to the directional information further comprises:
directing the display of the user interface of the electronic device to represent the display effect that is changed in a reflection direction of the directional information of the gesture.

7. The data transmission method of claim 1, wherein the directional information of the gesture is determined based on a reference vector, and the reference vector is a vector which is perpendicular to the display plane of the handheld device.

8. A handheld device, comprising:
a storage unit, comprising at least one file;
a touch-sensitive display unit; and
a processing unit, arranged for receiving a gesture input from the touch-sensitive display unit to determine whether the gesture input matches a predetermined gesture, and when the gesture input matches the predetermined gesture, obtaining directional information corresponding to the gesture input and transmitting the at least one file and the directional information to at least one electronic device, thereby directing a display of a user interface of the electronic device to generate a display effect corresponding to the gesture input according to the directional information.

9. The handheld device of claim 8, wherein the processing unit is further arranged for detecting a touch on the touch-sensitive display unit and determining whether the detected touch is the gesture input.

10. The handheld device of claim 8, wherein the electronic device further comprises a display unit, and the display plane of the display unit is perpendicular to the touch-sensitive display unit.

11. The handheld device of claim 8, wherein the predetermined gesture is a gesture representing a transmission request.

12. The handheld device of claim 8, wherein the at least one electronic device further comprises a plurality of electronic devices and the processing unit further transmits the file to one of the electronic devices according to the directional information.

13. The handheld device of claim 8, wherein the display of the user interface of the electronic device represents the display effect that is changed in a direction which is the same as the directional information of the gesture.

14. The handheld device of claim 8, wherein the display of the user interface of the electronic device represents the display effect that is changed in a direction opposite to the directional information of the gesture.

15. The handheld device of claim 8, wherein the display of the user interface of the electronic device represents the display effect that is changed in a reflection direction of the directional information of the gesture.

16. The handheld device of claim 8, wherein the processing unit further determines the directional information of the gesture by a reference vector, wherein the reference vector is a vector which is perpendicular to the display plane of the handheld device.

17. The handheld device of claim 16, further comprising a set of sensors, and the set of sensors comprises at least one of a G-sensor, a Gyroscope and an e-compass, wherein the processing unit further utilizes the set of sensors to obtain the reference vector.

18. A data transmission method, applied to an electronic device at least comprising a display unit, the method comprising:
receiving a file transmission request, wherein the file transmission request comprises directional information and a file; and
receiving the file, and generating a display effect corresponding to the directional information on the display of a user interface of the display unit.

19. The data transmission method of claim 18, wherein the step of generating the display effect corresponding to the directional information on the display of the user interface of the display unit further comprises:
generating the display effect that is changed in a direction which is the same as the directional information on the display of the user interface of the display unit.

20. The data transmission method of claim 18, wherein the step of generating the display effect corresponding to the directional information on the display of the user interface of the display unit further comprises:
generating the display effect that is changed in a direction opposite to the directional information on the display of the user interface of the display unit.

21. The data transmission method of claim 18, wherein the step of generating the display effect corresponding to the directional information on the display of the user interface of the display unit further comprises:
generating the display effect that is changed in a reflection direction of the directional information on the display of the user interface of the display unit.

22. The data transmission method of claim 18, wherein the directional information comprises velocity information, acceleration information, and an absolute vector information in the three dimensional space.

23. An electronic device, comprising:
a display unit, arranged for displaying a user interface; and
a processing unit, arranged for receiving a file transmission request comprising directional information and a file, and receiving the file and generating a display effect corresponding to the directional information on the display of the user interface of the display unit in response to the file transmission request.

24. A machine-readable storage medium comprising a computer program, which, when executed, causes a device to perform a data transmission method for a handheld device, wherein the method comprises:
receiving a gesture input from a touch-sensitive display unit;
determining whether the gesture input matches a predetermined gesture; and
when determining that the gesture input matches the predetermined gesture, obtaining directional information corresponding to the gesture input and transmitting a file and the directional information to at least one electronic device, thereby directing a display of a user interface of the electronic device to generate a display effect corresponding to the gesture input according to the directional information.
